(19) United States
(12) Patent Application Publication
(10) Pub. No.: US 2015/0149889 A1
(43) Pub. Date: May 28, 2015

(54) DISPLAYING PAGE ELEMENTS

(71) Applicant: Alibaba Group Holding Limited, George Town (KY)

(72) Inventor: Tengfei Yang, Hangzhou (CN)

(21) Appl. No.: 14/546,771

(22) Filed: Nov. 18, 2014

(30) Foreign Application Priority Data
Nov. 28, 2013 (CN) 201310624842.X

(51) Int. Cl. G06F 3/0483; G06F 17/22; G06F 3/0484

(52) U.S. Cl. CPC G06F 3/0483; G06F 3/04842; G06F 17/2247
USPC 715/234

(57) ABSTRACT

Display page elements is disclosed, including: presenting a first set of page elements associated with the web page to be presented, wherein the web page is associated with a second set of page elements that is not presented; and overlaying a mobile object on the web page, wherein the mobile object comprises a floating page element; detecting a movement associated with the mobile object; determining that the movement meets a condition associated with displaying at least one page element of the second set of page elements that is not presented; and presenting the at least one page element associated with the condition.

### CROSS REFERENCE TO OTHER APPLICATIONS

This application claims priority to People's Republic of China Patent Application No. 201310624842.X entitled METHOD AND DEVICE FOR CONTROLLING PAGE ELEMENTS, filed Nov. 28, 2013 which is incorporated herein by reference for all purposes.

### FIELD OF THE INVENTION

The present application relates to World Wide Web (Web) page processing technology. In particular, the present application relates to techniques for displaying page elements.

### BACKGROUND OF THE INVENTION

As communication technologies have developed, client devices have integrated more and more features. As a result, a client device is likely to run more and more applications. Example applications include applications installed on computers and third party applications installed on mobile devices. Some applications load some World Wide Web (web) pages. A web page may include a display block composed of one or more HyperText Markup Language (HTML) tags called “page elements.” Examples of page elements include text, tags, hyperlinks, buttons, input boxes, and pull-down boxes, etc. In some situations, it is necessary to conceal, i.e., not display, some page elements on the page. For example, if the dimensions of the terminal screen are too small to display all of the page elements on a web page, then fewer than all of the page elements of a web page may be displayed at once in the terminal screen. Conventionally, an application or web page can provide a function button at a designated position on the web page that can be selected to display the concealed page elements. When a user selects the function button, the corresponding concealed page elements will be displayed.

However, the function button for displaying concealed page elements is typically set at a static position on a web page or application interface. Therefore, when a user needs to browse concealed page elements, he or she would first need to potentially scroll up or down on the web page to search for the appropriate function button at its static location on the page. Searching for the static location on the page for each function button may be inconvenient and inefficient for causing the display of concealed page elements.

### BRIEF DESCRIPTION OF THE DRAWINGS

Various embodiments of the invention are disclosed in the following detailed description and the accompanying drawings.

FIG. 1 is a system diagram showing an embodiment of a system for displaying page elements.

FIG. 2 is a flow diagram showing an embodiment of a process for displaying page elements.

FIG. 3 is a flow diagram showing an example process of displaying page elements.

FIG. 4 is a diagram showing an example of a display area of a client device.

FIG. 5 is a flow diagram showing an example of displaying page elements of a web page by moving a mobile object to reach a position object.

FIG. 6 shows an example of displaying page element A1 in response to mobile object B1 having reached position object B2.

FIG. 7 shows an example of displaying page element A2 in response to mobile object B1 having reached position object B3.

FIG. 8 is a flow diagram showing an example of displaying page elements of a web page by moving a mobile object by at least a preset length.

FIG. 9 shows an example of displaying page element A3 in response to mobile object B1 having been moved a preset length upwards from its initial position.

FIG. 10 shows an example of displaying page element A3 in response to mobile object B1 having been moved a preset length downwards from its initial position.

FIG. 11 shows a diagram of a system for displaying page elements.

FIG. 12 is a functional diagram illustrating an embodiment of a programmed computer system for implementing the display of page elements.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Embodiments of displaying page elements are described herein. In various embodiments, a “page element” refers to a display element at a web page. In some embodiments, a page element comprises one or more HyperText Markup Language (HTML) tags. Examples of a page element include a text field, a hyperlink, a tag, a button, an input box, a pull-down box, a radio button, an image, and any type of selection. A first set of page elements associated with a web page is presented (e.g., in a display area of a client device). The web page is also associated with a second set of page elements that is not presented. A mobile object is overlaid on the web page. The mobile object comprises a floating page element. In various embodiments, a “floating page element” comprises a page element that is located at the same location in a display area and/or webpage even if the webpage is scrolled/moved. For example, a floating page element can be implemented using HTML and/or cascade style sheets (CSS). A movement associated with the mobile object (e.g., that is caused by a user action) is detected. It is determined that the movement associated with the mobile object meets a condition associated with displaying at least one page element of the second set of page elements that is not currently presented. The at least one page element associated with the condition is then presented (e.g., in the display area of the client device).

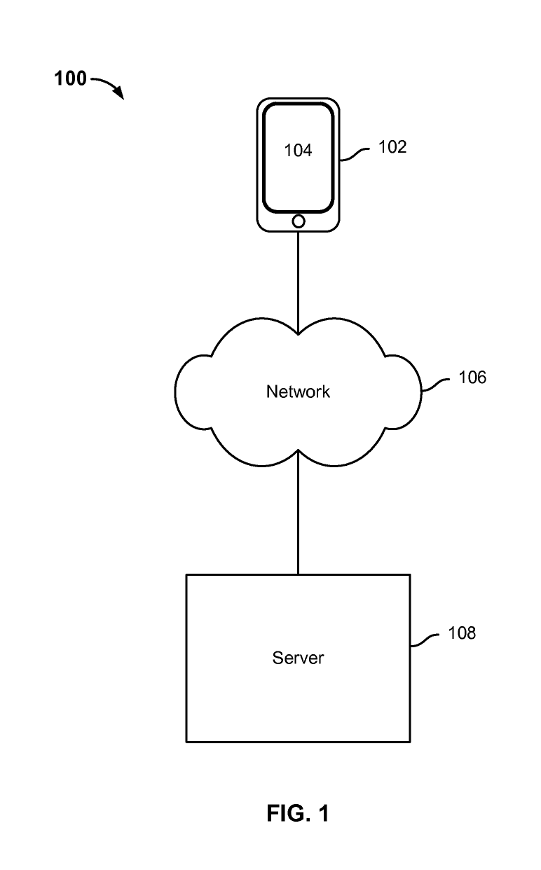

FIG. 1 is a system diagram showing an embodiment of a system for displaying page elements. In this example, system 100 includes client device 102, network 106, and server 108. Network 106 comprises high-speed data networks and/or telecommunications networks. Client device 102 is configured to communicate to server 108 over network 106.

Client device 102 includes display area 104. Display area 104 may comprise any type of user and/or display interface. Examples of client device 102 include a mobile device, a smart phone, a tablet device, a desktop computer, a laptop computer, and/or any computing device. In some embodiments, display area 104 comprises a touchscreen. In various embodiments, client device 102 is configured to execute one or more applications. Applications executed at client device 102 may include browser applications and/or non-browser applications.

An application executed at client device 102 may be configured to request data associated with a web page (e.g., in response to a user interaction) from server 108. Server 108 is configured to send the requested web page data to client device 102. The web page data includes several page elements. Examples of page elements include a text field, a hyperlink, a tag, a button, an input box, a pull-down box, a radio button, an image, and any type of selection. However, the limited dimensions of display area 104 typically allow for the presentation of only a subset of the page elements of the web page at client device 102 at a time. As a result, in rendering the web page, display area 104 of client device 102 will initially present only some of the page elements of the web page, while the remaining page elements of the web page will not be displayed at display area 104 of client device 102 until a condition is satisfied.

As will be described below, a mechanism referred to as a “mobile object” that comprises a floating page element overlaid on the portion of web page presented at display area 104 of client device 102 can enable a user to trigger the presentation of at least some of the page elements that are not currently displayed at display area 104. In various embodiments, a user may select the mobile object presented at display area 104 of client device 102 and move the mobile object across a portion of display area 104. In the event that the movement associated with the mobile object meets a condition associated with displaying at least one page element that is not currently displayed at display area 104 of client device 102, the at least one page element corresponding to that condition will be presented at display area 104. In some embodiments, the mobile object is generated based on computer code, HTML, cascade style sheets (CSS), and/or script (e.g., JavaScript) that is included in the web page data and may be executed, at least in part, at server 108. In some embodiments, the mobile object is generated based on logic and/or computer code associated with the application executed at client device 102.

With the mobile object as described herein, a user no longer needs to search for and select static buttons on the web page to cause the presentation of various corresponding page elements. Furthermore, without maintaining static buttons to trigger the presentation of various corresponding page elements, the web page can include more content that is of interest to a user and in a more appealing layout.

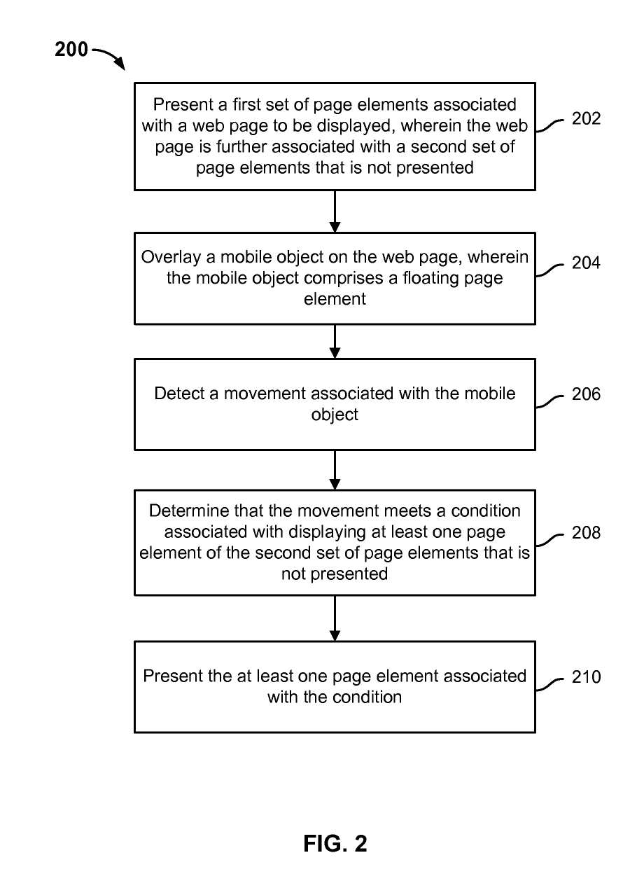

FIG. 2 is a flow diagram showing an embodiment of a process for displaying page elements. In some embodiments, process 200 is implemented at a system such as system 100 of FIG. 1.

At 202, a first set of page elements associated with a web page to be displayed is presented, wherein the web page is further associated with a second set of page elements that is not presented.

A web page that is desired to be loaded may include several page elements. In some embodiments, the web page is loaded in a browser application and in some other embodiments, the web page is loaded in a non-browser (e.g., a stand-alone) application. As described above, a page element may comprise any type of display element of the web page, including elements with which users can interact (e.g., buttons, text fields, pull-down menus, radio button selections, hyperlinks) and elements with which users cannot interact (e.g., text, images). Depending on the dimensions of the display area of the client device on which the web page is loaded, it is likely that fewer than all of the page elements on the web page can be displayed at once in the display area. As such, a portion of the page elements included in a web page is presented in the display area of the client device at once while the remaining page elements of the web page will be presented in response to certain triggers involving the movement of a mobile object, as will be described below.

At 204, a mobile object is overlaid on the web page, wherein the mobile object comprises a floating page element.

A mobile object comprises a floating page element that is overlaid on the web page. Because the mobile object is implemented as a floating page element (e.g., by the HTML and/or CSS of the webpage data), the mobile object is seemingly displayed over the webpage by the application in which the webpage is loaded, even as the webpage is scrolled (e.g., using a mechanism other than the mobile object itself). In some embodiments, the mobile object is overlaid on the web page at an initial position within the display area of the client device. The mobile object may be moved from its initial position (e.g., in response to a user selection/action). In some embodiments, the mobile object is generated based on computer code, cascade style sheets (CSS), and/or script (e.g., JavaScript) that is included in the web page data associated with the web page (e.g., received from a server). In some embodiments, the mobile object is generated based on logic and/or computer code associated with the application (e.g., stored at the client device) in which the web page is loaded.

In various embodiments, a position of an object refers to at least a two-dimensional coordinate within the display area of the client device.

In various embodiments, the initial position of the mobile object is determined relative to the dimensions of the display area of the client device. For example, the initial position of the mobile object can be determined to be near the center bottom of the client device's display area. In some embodiments, the mobile object will remain at its initial position and overlay/float over the web page whenever the web page is scrolled by a mechanism other than the mobile object. Put another way, if the mobile object is not engaged by the user, the mobile object will remain in its initial position even if the web page is otherwise scrolled.

The appearance of the mobile object may be any shape. For example, the shape of the mobile object may be oval, square, or any polygon. The mobile object may be any size. In some embodiments, the mobile object is sized so as to be movable by a user with one hand/finger for convenience of usage. The transparency of the mobile object may be greater than or equal to 0 and less than 1, where the larger the transparency value is, the greater the indicated transparency. As such, 0 indicates entirely opaque.

At 206, a movement associated with the mobile object is detected.

The floating mobile object is selectable and movable over the display area by a user via an input interface of the client device. For example, if the display area of the client device were a touchscreen, then the user can use a finger to select the mobile object and drag it in any direction for any distance across the display area. In another example, the mobile object may also be moved via a stylus or a cursor. The mobile object may be selected and moved in any manner. In some embodiments, the movement of the mobile object is measured relative to its initial position on the display area of the client device.

The length and/or direction of the movement of the mobile object will determine which page elements of the web page that are not currently displayed in the display area of the client device will be displayed in the display area (and which page elements that are currently displayed and will no longer be displayed in the display area).

In some embodiments, one or more floating position objects are overlaid on the web page. A position object comprises a fixed (e.g., unmovable) page element. In some embodiments, each position object is generated based on computer code, HTML, cascade style sheets (CSS), and/or script (e.g., JavaScript) that is included in the web page data associated with the web page. In some embodiments, each position object is generated based on logic and/or computer code associated with the application in which the web page is loaded. In some embodiments, a position object is overlaid on the web page at a corresponding fixed position within the display area of the client device. In some embodiments, the fixed position of a position object may be configured to be within a certain length and/or direction from the initial position of the mobile object. For example, the fixed position of each position object may be at least in the vicinity (e.g., within a predetermined distance) of the mobile object. In some embodiments, the fixed position of each position object is determined relative to the dimensions of the display area of the client device and/or the initial position of the mobile object. For example, the fixed position of a position object can be determined to be near the bottom of the client device's display area to either the left or the right direction of the mobile object. Unlike the mobile object, a position object cannot be moved from its fixed position. A position object will overlay/float over the web page when the web page is scrolled (e.g., using the mobile object or by another technique). The appearance of a position object may be any shape. The shape of a position object may be oval, square, or any polygon. In some embodiments, the shape of each position object may be configured to be similar to the shape of the mobile object. The transparency of a position object may be greater than or equal to 0 and less than 1, where the larger the transparency value is, the greater the indicated transparency. As such, 0 indicates entirely opaque.

At 208, it is determined that the movement meets a condition associated with displaying at least one page element of the second set of page elements that is not presented.

In various embodiments, a set of rules associated with displaying page elements of the web page that are not currently displayed at the display area of the client device is stored. For example, each rule describes an attribute (e.g., a length, an orientation, a direction, a shape, an offset associated with the release of the mobile object, the coordinates associated with the release of the mobile object, etc.) of a movement that meets a condition for displaying at least one page element of the web page that is not currently displayed in the display area of the client device. In some embodiments, each rule indicates specifically which one or more currently not displayed page elements should be displayed and/or which area of the display area such page elements are to be displayed if the corresponding condition is met. Furthermore, in some embodiments, each rule may also describe which, if any, page elements that are currently displayed in the display area of the client device should no longer be displayed in the display area.

In some embodiments, a rule associated with displaying page elements of the web page that are not currently displayed at the display area of the client device indicates that if the movement of the mobile object reaches a position object, then a condition to display at least one page element of the web page that is not currently displayed in the display area of the client device is met. For example, the movement of the mobile object can be determined to reach a position object if the position object is completely covered or at least partially covered (e.g., covered by at least a preset coverage threshold value) by the mobile object and/or if the mobile object is moved from its initial position to a final position (e.g., the final position to which the mobile object was moved by the user) within a predetermined radius from the position of the fixed position of the position object. For example, to allow users to conveniently select and drag a mobile object to reach a position object, the distance in between the initial position of the mobile object and the fixed position of the position object should be set so that a user can easily move the mobile object to reach the position object using one hand. In a specific example where the client device comprises a touchscreen mobile phone, the movement of the mobile object can be monitored by recording the coordinates where the user's finger stops touching/releases the mobile object on the touchscreen and comparing such coordinates to the fixed position of at least one of the position objects. Whether the coordinates where the user's finger stops touching/releases the mobile object on the touchscreen matches (e.g., within a given tolerance) to the fixed position of at least one of the position objects is used determined whether the movement of the mobile object satisfies a condition of a rule.

In some embodiments, a rule associated with displaying page elements of the web page that are not currently displayed at the display area of the client device indicates that if the length of the movement of the mobile object is at least a preset length and/or is in a particular direction relative to the initial position of the mobile object, then a condition to display at least one page element of the web page that is not currently displayed in the display area of the client device is met. For example, the rule can specify that if the length of the movement of the mobile object is at least a preset length (e.g., 3 cm) and extends in a preset direction (e.g., up or down) from the initial position of the mobile object, then a corresponding condition is met. In a specific example where the client device comprises a touchscreen mobile phone, the movement of the mobile object can be monitored by recording the offset value (e.g., a measured distance) from the coordinates where the user's finger begins to touch the mobile object on the touchscreen to the coordinates where the user's finger stops touching/releases the mobile object. The offset value can be used to determine whether the movement of the mobile object satisfies a condition of a rule.

The not currently displayed page elements to be displayed corresponding to different conditions may include at least some of the same page elements and/or include completely different page elements. The not currently displayed page elements to be displayed corresponding to different conditions may be displayed in the same or different areas of the display area of the client device.

At 210, the at least one page element associated with the condition is presented.

The at least one page element of the web page that is not currently displayed in the display area of the client device indicated in the rule whose condition was met by the movement of the mobile object is displayed in the display area of the client device. As described above, in some embodiments, each rule indicates specifically which one or more currently not displayed page elements should be displayed and also, in which area of the display area of the client device to display them, if the corresponding condition is met.

As described above, in some embodiments, each rule may also describe which, if any, page elements that are currently displayed in the display area of the client device should no longer be displayed in the display area of the client device. In some embodiments, to ensure that there is not too much content being presented in the display area, if a condition to present at least one not currently displayed page element is met, at least one page element that was previously presented becomes at least partially hidden to yield more display area for the newly displayed page elements.

In some embodiments, the rule associated with the met condition also indicates when to hide at least one page element that was previously presented. For example, whether to hide at least one page element that was previously presented is determined by the dimensions of the display area of the client device and the difference between the dimensions of the display area and the dimensions of the one or more currently not displayed page elements that should be displayed corresponding to the met condition.

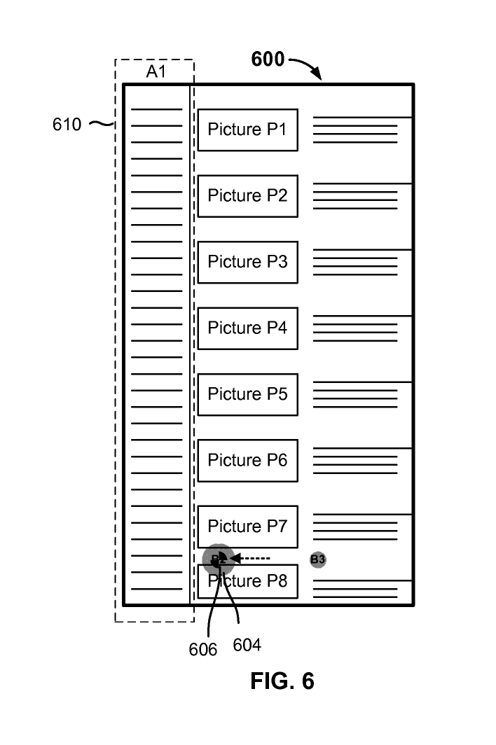

In a first example, if the dimensions of the display area of the client device excluding the one or more currently not displayed page elements that should be displayed corresponding to the met condition are sufficient to display the entirety of the previously displayed page elements, then all of the previously displayed page elements can remain on display. As will be described in further detail below, FIG. 6, below shows an example of displaying the entirety of the previously displayed page elements after displaying the page elements corresponding to a condition met by the movement associated with the mobile object.

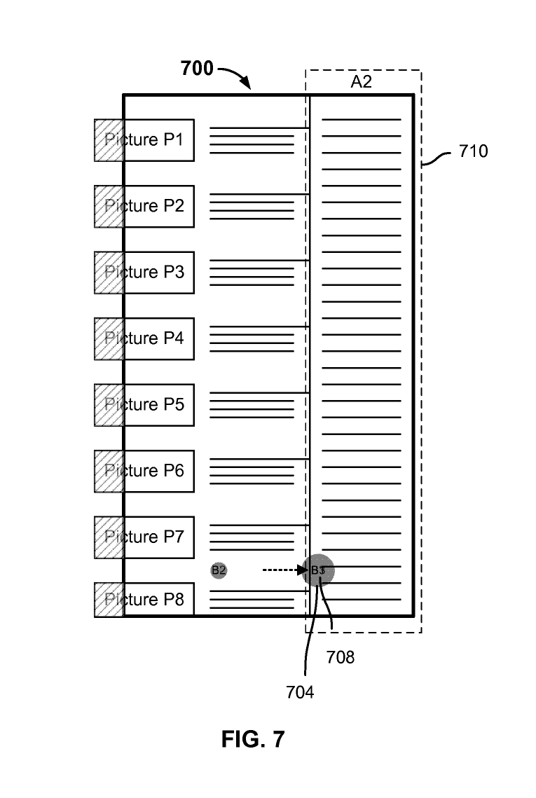

In a second example, if the dimensions of the display area of the client device excluding the one or more currently not displayed page elements that should be displayed corresponding to the met condition are not sufficient to display the entirety of the previously displayed page elements, then a portion of the previously displayed page elements can remain displayed and the remaining portion of the previously displayed page elements can be hidden from display. As will be described in further detail below, FIGS. 7, 9, and 10, below each shows an example of displaying a portion of the previously displayed page elements after displaying the page elements corresponding to a condition met by the movement associated with the mobile object.

In a third example, if the one or more currently not displayed page elements that should be displayed corresponding to the met condition occupy the entire display area of the client device, then all of the previously displayed page elements can be hidden.

In some other embodiments, preset configuration information associated with the client device and/or the web page data and/or the server indicates when to hide at least one page element that was previously presented. For example, configuration information may be used to instruct that one or more currently not displayed page elements that should be displayed corresponding to the met condition are to be displayed and that all previously displayed page elements will be hidden.

As such, the mobile object described herein enables a user to conveniently trigger the display of page elements of a web page that are not currently displayed by simply using a floating page element (a mobile object), without needing to search for a control button that is statically placed on a web page.

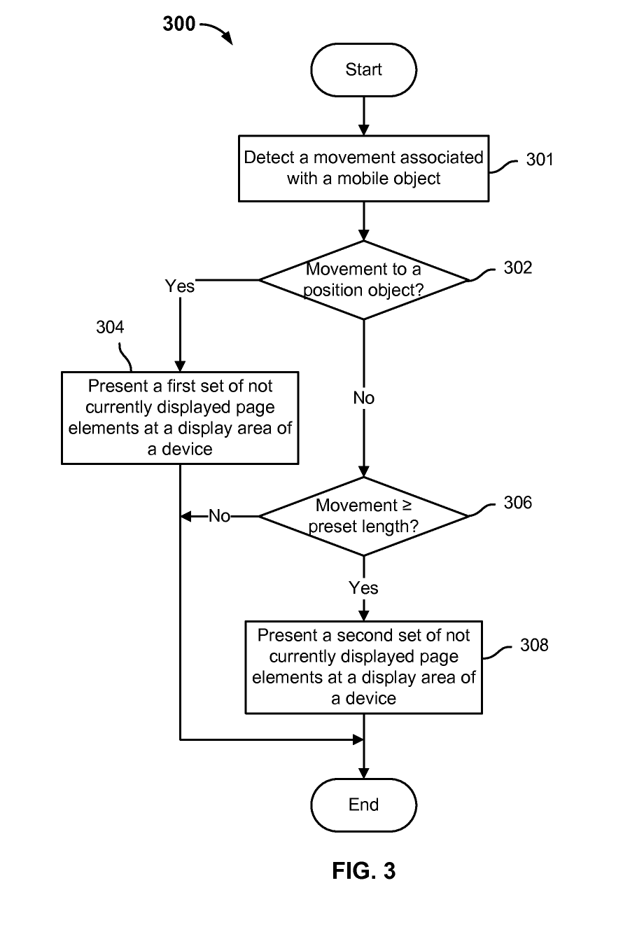

FIG. 3 is a flow diagram showing an example process of displaying page elements. In some embodiments, process 300 is implemented at a system such as system 100 of FIG. 1. In some embodiments, steps 206, 208, and 210 of process 200 of FIG. 2 may be implemented at least in part using process 300.

At 301, a movement associated with a mobile object is detected. Some page elements of a web page are displayed in a display area of a client device while some page elements of the web page are not currently displayed. A mobile object comprising a floating page element has been overlaid on the web page in the display area. The mobile object has been moved by a user (e.g., by the user selecting and dragging the mobile object using his or her finger).

At 302, it is determined whether a movement associated with a mobile object has reached a position object. In the event that the movement of the mobile object has reached the position object, control is transferred to 304. Otherwise, in the event that the movement of the mobile object has not reached the position object, control is transferred to 306. In some embodiments, the mobile object being moved to reach at least one of potentially multiple position objects may be a condition to display at least one page element that is not currently displayed in the display area of the client device. For example, a mobile object being moved to reach a position object may be determined if the position object is completely covered or at least partially covered (e.g., covered by at least a preset coverage threshold value) by the mobile object and/or if the mobile object is moved from its initial position to a final position (e.g., the final position to which the mobile object was moved by the user) within a predetermined radius from the position of the fixed position of the position object.

At 304, a first set of not currently displayed page elements is presented at a display area of a device. For example, a set of not currently displayed page elements can be configured to be displayed in response to the condition of the mobile object reaching that particular position object being met. This corresponding set of not currently displayed page elements can be displayed in a particular area of the display area of the client device corresponding to the met condition.

At 306, it is determined whether a length of a movement associated with a mobile object has met or exceeded a preset length. In the event that the movement has exceeded a preset length, control is transferred to 308. Otherwise, in the event that the movement has not exceeded a preset length, process 300 ends. In some embodiments, the mobile object being moved by more than at least a preset length (e.g., in a particular direction) may be a condition to display at least one page element that is not currently displayed in the display area of the client device.

At 308, a second set of not currently displayed page elements is presented at a display area of a device. For example, a set of not currently displayed page elements can be configured to be displayed in response to the condition of the mobile object being moved by at least the preset length (e.g., in a particular direction). This corresponding set of not currently displayed page elements can be displayed in a particular area of the display area of the client device corresponding to the met condition.

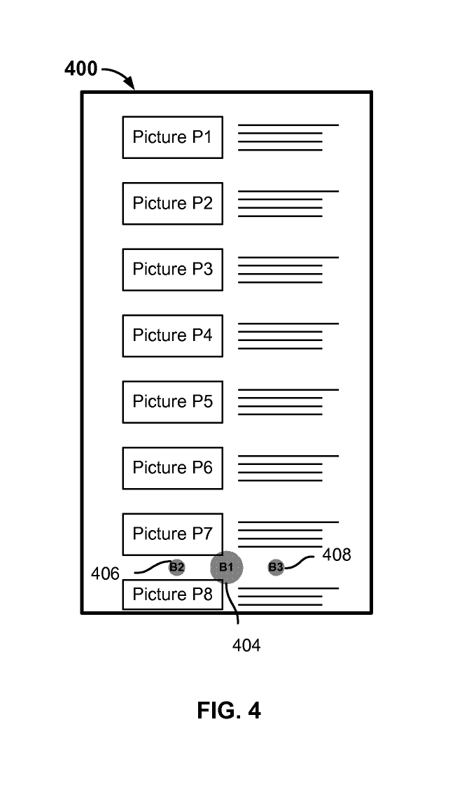

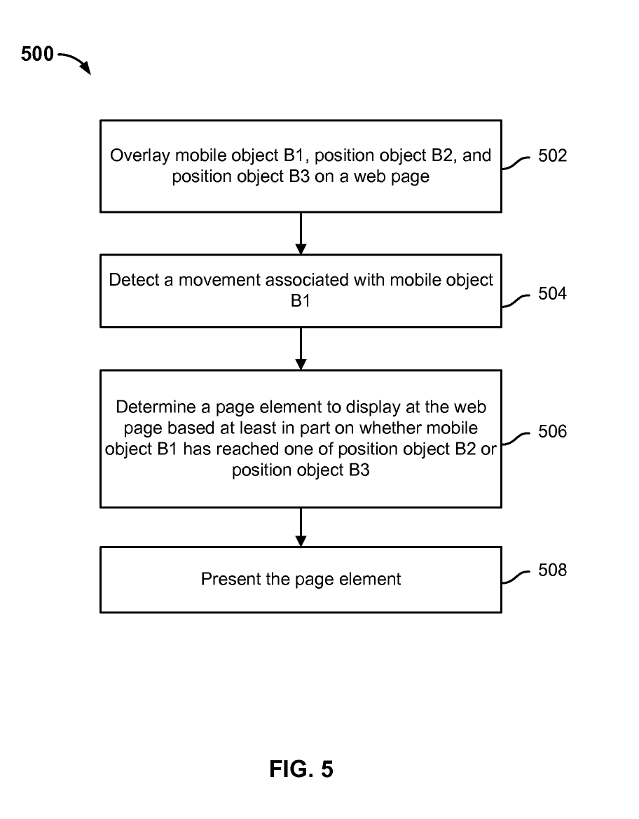

FIG. 4 is a diagram showing an example of a display area of a client device. In the example, display area 400 includes the display of several page elements (e.g., Picture P1, Picture P2, Picture P3, Picture P4, Picture P5, Picture P6, Picture P7, Picture P8, and their respective accompanying text) of a web page. However, other page elements of the web pages including page element A1, page element A2, page element A3, and page element A4 are not currently displayed at display area 400. Display area 400 also includes mobile object B1 404, position object B2 406, and position B3 408, each of which comprises a floating page element that is overlaid on the web page. In the example of FIG. 4, mobile object B1 404 is shown in its initial position (e.g., near the center bottom of display area 400) and each of position object B2 406 and position object B3 408 is shown in its respective fixed position. As will be described below with FIGS. 5 through 10, a user can move a mobile object such as mobile object 404 to cause the display of the page elements of the web page that are not currently displayed in the display area such as display area 400.

FIG. 5 is a flow diagram showing an example of displaying page elements of a web page by moving a mobile object to reach a position object. In some embodiments, process 500 is implemented at a system such as system 100 of FIG. 1. In some embodiments, steps 204, 206, 208, and 210 of process 200 of FIG. 2 may be implemented at least in part using process 500. In some embodiments, steps 301, 302, and 304 of process 300 of FIG. 3 may be implemented at least in part using process 500.

Process 500 describes using a movement of a mobile object, mobile object B1, to a position object, either position object B2 or position object B3, to determine which currently not displayed page elements of a web page should be displayed in a display area of a client device.

At 502, a mobile object B1, position object B2, and position object B3 are overlaid on a web page. For example, referring back to the example of FIG. 4, display area 400 shows mobile object B1 404 in its initial position and each of position object B2 406 and position object B3 408 in its respective fixed position. At 504, a movement associated with mobile object B1 is detected. For example, if the display area of the client device were associated with a touchscreen, mobile object B1 could be moved by a user selecting mobile object B1, dragging selected mobile object B1 in a particular direction, and releasing the selected mobile object B1. At 506, a page element to display at the web page is determined based at least in part on whether mobile object B1 has reached one of position object B2 or position object B3. It is determined whether the movement of mobile object B1 has met a condition associated with reaching either one of position object B2 or position object B3. For example, if mobile object B1 is determined to have met the condition of reaching position object B2, the not currently displayed page element (e.g., page element A1) corresponding to position object B2 will be displayed. FIG. 6, below, shows an example of displaying page element A1 in a display area of a client device. Or, for example, if mobile object B1 is determined to have met the condition of reaching position object B3, the not currently displayed page element (e.g., page element A2) corresponding to position object B2 will be displayed. FIG. 7, below, shows an example of displaying page element A2 in a display area of a client device. At 508, the page element is presented. The not currently displayed page element(s) corresponding to whichever one of position object B2 or position object B3 that mobile object B1 had reached is displayed within the display area of the client device.

FIG. 6 shows an example of displaying page element A1 in response to mobile object B1 having reached position object B2. As described in the example of process 500 of FIG. 5, in the event that mobile object B1 is determined to have met the condition of reaching position object B2, the not currently displayed page element A1 corresponding to position object B2 will be displayed. The example of FIG. 6 shows display area 600 after mobile object B1 604 has been moved from its original initial position near the center bottom of display area 600 to cover position object B2 606 and therefore meets a condition associated with reaching position object B2 606. In response to mobile object B1 604 reaching position object B2 606, page element A1 610 corresponding to position object B2 606 is displayed at the left side of display area 600. In the example of FIG. 6, the page elements that were previously displayed at display area 600 (e.g., Picture P1, Picture P2, Picture P3, Picture P4, Picture P5, Picture P6, Picture P7, Picture P8, and their respective accompanying text) were determined to remain completely displayed with the display of page element A1, except the previously displayed page elements were shifted further to the right side of display area 600 to provide more area to display page element A1. For example, the page elements that were previously displayed at display area 600 were determined to remain completely displayed with the display of page element A1 because the remaining area of display area 600 after displaying only page element A1 was large enough to keep the display of the previously displayed page elements. For example, the previously displayed page elements comprise various sets of product information and a corresponding picture of each product from a particular product category and page element A1 may comprise a list of other product categories that a user can select to view.

While not shown in the example of FIG. 6, a user who has selected and has started to move mobile object B1 604 towards position object B2 606 may cancel the operation by pulling away/releasing/deselecting mobile object B1 604 before mobile object B1 604 is able to reach position object B2 606. In this case, mobile object B1 604 returns to its initial position and page element A1 is not displayed at display area 600. In other words, the operation to move mobile object B1 604 may be canceled at any time prior to the movement of mobile object B1 604 meeting a condition for displaying a not currently displayed page element.

FIG. 7 shows an example of displaying page element A2 in response to mobile object B1 having reached position object B3. As described in the example of process 500 of FIG. 5, in the event that mobile object B1 is determined to have met the condition of reaching position object B3, the not currently displayed page element A2 corresponding to position object B2 will be displayed. The example of FIG. 7 shows display area 700 after mobile object B1 704 has been moved from its original initial position near the center bottom of display area 700 to cover position object B3 708 and therefore meets a condition associated with reaching position object B3 708. In response to mobile object B1 704 reaching position object B3 708, page element A2 710 corresponding to position object B3 708 is displayed at the right side of display area 700. In the example of FIG. 7, the page elements that were previously displayed at display area 700 (e.g., Picture P1, Picture P2, Picture P3, Picture P4, Picture P5, Picture P6, Picture P7, Picture P8, and their respective accompanying text) were determined to remain partially displayed with the display of page element A2 and partially hidden from display area 700 (e.g., the grayed out portion of the previously displayed page elements that extend beyond the left side of display area 700 is no longer displayed at display area 700). For example, the page elements that were previously displayed at display area 700 were determined to be partially displayed with the display of page element A2 because the remaining area of display area 700 after displaying only page element A2 was large enough to keep the display of only a portion of the previously displayed page elements. For example, the previously displayed page elements comprise various sets of product information and a corresponding picture of each product from a particular product category and page element A2 may comprise a list of products that have been previously viewed by the user.

While not shown in the example of FIG. 7, a user who has selected and has started to move mobile object B1 704 towards position object B3 708 may cancel the operation by pulling away/releasing/deselecting mobile object B1 704 before mobile object B1 704 is able to reach position object B3 708. In this case, mobile object B1 704 returns to its initial position and page element A2 is not displayed at display area 700. In other words, the operation to move mobile object B1 704 may be canceled at any time prior to the movement of mobile object B1 704 meeting a condition for displaying a not currently displayed page element.

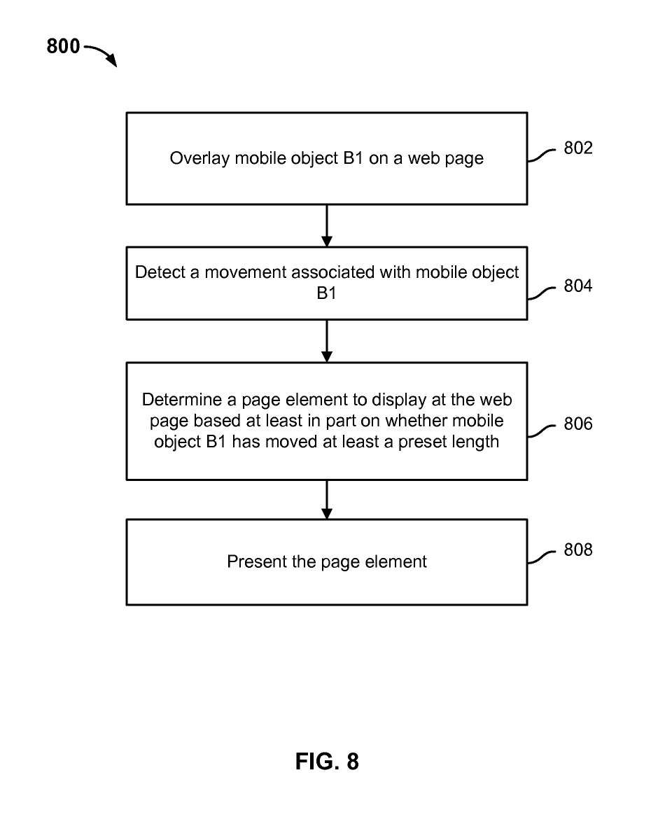

FIG. 8 is a flow diagram showing an example of displaying page elements of a web page by moving a mobile object by at least a preset length. In some embodiments, process 800 is implemented at a system such as system 100 of FIG. 1. In some embodiments, steps 204, 206, 208, and 210 of process 200 of FIG. 2 may be implemented at least in part using process 500. In some embodiments, steps 301, 306, and 308 of process 300 of FIG. 3 may be implemented at least in part using process 800.

Process 800 describes using a movement of a mobile object, mobile object B1, by at least a preset length to determine which currently not displayed page elements of a web page should be displayed in a display area of a client device.

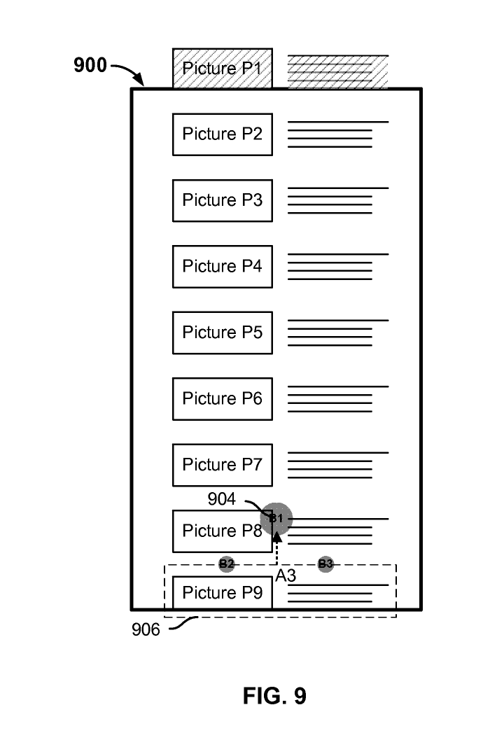

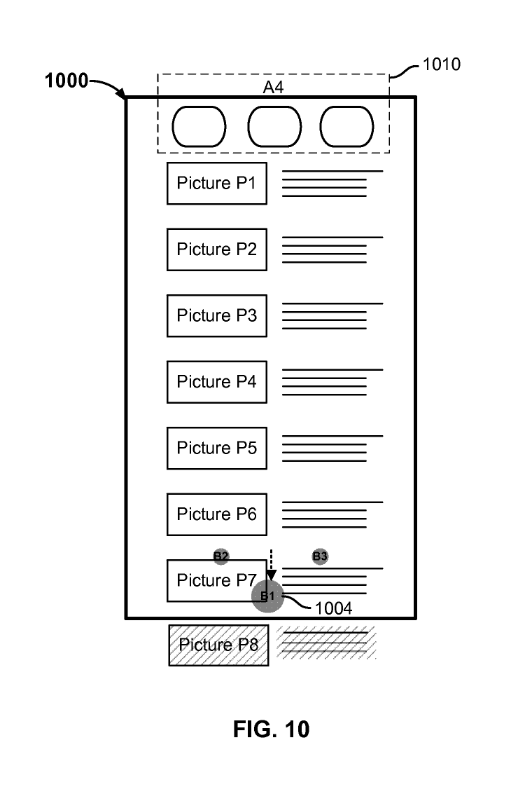

At 802, a mobile object B1 is overlaid on a web page. For example, referring back to the example of FIG. 4, display area 400 shows mobile object B1 404 in its initial position and each of position object B2 406 and position object B3 408, which are optionally displayed, in its respective fixed positions. At 804, a movement associated with mobile object B1 is detected. For example, if the display area of the client device were associated with a touchscreen, mobile object B1 could be moved by a user selecting mobile object B1, dragging selected mobile object B1 in a particular direction, and releasing the selected mobile object B1. At 806, a page element to display at the web page is determined based at least in part on whether mobile object B1 has moved at least a preset length. For example, if mobile object B1 is determined to have met the condition of moving at least a preset length, and also in a preset direction relative to its initial position, a not currently displayed page element corresponding to that preset direction is displayed. For example, if mobile object B1 is determined to have moved at least a preset length in the up direction relative to its initial position, not currently displayed page element A3 corresponding to the up direction is displayed. FIG. 9, below, shows an example of displaying page element A3 in a display area of a client device. Or, in another example, if mobile object B1 is determined to have moved at least a preset length in the down direction relative to its initial position, not currently displayed page element A4 corresponding to the up direction is displayed. FIG. 10, below, shows an example of displaying page element A4 in a display area of a client device. At 808, the page element is presented. The not currently displayed page element(s) corresponding to whichever direction in which mobile object B1 had moved at least the preset length is displayed within the display area of the client device.

FIG. 9 shows an example of displaying page element A3 in response to mobile object B1 having been moved a preset length upwards from its initial position. As described in the example of process 800 of FIG. 8, in the event that mobile object B1 is determined to have met the condition of having moved a preset length in the up direction, the not currently displayed page element A3 will be displayed. The example of FIG. 9 shows display area 900 after mobile object B1 904 has been moved from its original initial position near the center bottom of display area 900 upwards by at least a preset length and therefore meets a condition associated with having moved by at least the preset length in the up direction. In response to mobile object B1 904 having moved by at least the preset length in the up direction, page element A3 910 corresponding to such a movement is displayed at the bottom of display area 900. In the example of FIG. 9, the page elements that were previously displayed at display area 900 (e.g., Picture P1, Picture P2, Picture P3, Picture P4, Picture P5, Picture P6, Picture P7, Picture P8, and their respective accompanying text) were determined to remain partially displayed with the display of page element A4 and partially hidden from display area 900 (e.g., the grayed out portion of the previously displayed page elements that extends beyond the top of display area 900 is no longer displayed at display area 900). For example, the page elements that were previously displayed at display area 900 were determined to be partially displayed with the display of page element A3 because the remaining area of display area 900 after displaying only page element A3 was large enough to keep the display of only a portion of the previously displayed page elements. For example, the previously displayed page elements comprise various sets of product information and a corresponding picture of each product from a particular product category and page element A3 may comprise another set of product information that was not previously visible in the display area.

While not shown in the example of FIG. 9, a user who has selected and has started to move mobile object B1 904 upwards may cancel the operation by pulling away/releasing/deselecting mobile object B1 904 before mobile object B1 904 is moved at least the preset length. In this case, mobile object B1 904 returns to its initial position and page element A3 is not displayed at display area 900. In other words, the operation to move mobile object B1 904 may be canceled at any time prior to the length of the movement of mobile object B1 904 meeting a condition for displaying a not currently displayed page element.

FIG. 10 shows an example of displaying page element A3 in response to mobile object B1 having been moved a preset length downwards from its initial position. As described in the example of process 800 of FIG. 8, in the event that mobile object B1 is determined to have met the condition of having moved a preset length in the down direction, the not currently displayed page element A4 will be displayed. The example of FIG. 10 shows display area 1000 after mobile object B1 1004 has been moved from its original initial position near the center bottom of display area 1000 downwards by at least a preset length and therefore meets a condition associated with having moved by at least the preset length in the down direction. In response to mobile object B1 1004 having moved by at least the preset length in the down direction, page element A4 1010 corresponding to such a movement is displayed at the top of display area 1000. In the example of FIG. 10, the page elements that were previously displayed at display area 1000 (e.g., Picture P1, Picture P2, Picture P3, Picture P4, Picture P5, Picture P6, Picture P7, Picture P8, and their respective accompanying text) were determined to remain partially displayed with the display of page element A4 and partially hidden from display area 1000 (e.g., the grayed out portion of the previously displayed page elements that extends beyond the bottom of display area 1000 is no longer displayed at display area 1000). For example, the page elements that were previously displayed at display area 1000 were determined to be partially displayed with the display of page element A4 because the remaining area of display area 1000 after displaying only page element A4 was large enough to keep the display of only a portion of the previously displayed page elements. For example, the previously displayed page elements comprise various sets of product information and a corresponding picture of each product from a particular product category and page element A4 may comprise a set of menu buttons (e.g., such as return to home, contact the web site owner, receive more information about the website).

While not shown in the example of FIG. 10, a user who has selected and has started to move mobile object B1 1004 downwards may cancel the operation by pulling away/releasing/deselecting mobile object B1 1004 before mobile object B1 1004 is moved at least the preset length. In this case, mobile object B1 1004 returns to its initial position and page element A4 is not displayed at display area 1000. In other words, the operation to move mobile object B1 1004 may be canceled at any time prior to the length of the movement of mobile object B1 1004 meeting a condition for displaying a not currently displayed page element.

As described herein, different detected movements of a mobile object can correspond to the display of different page elements that are not currently displayed in a display area of a client device. As such, in various embodiments, using a mobile object will obviate the need to set up multiple buttons on the web page, each corresponding to triggering the display of a different set of page elements. As a result, the web page layout can maximum more content that may be of interest to a user.

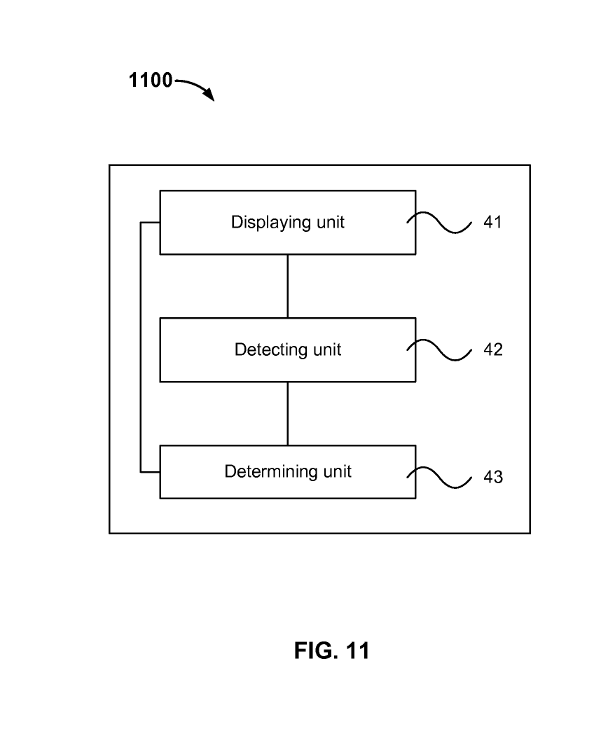

FIG. 11 shows a diagram of a system for displaying page elements. In the example, system 1100 includes displaying unit 41, detecting unit 42, and determining unit 43.

The units can be implemented as software components executing on one or more processors, as hardware such as programmable logic devices, and/or Application Specific Integrated Circuits designed to elements can be embodied by a form of software products which can be stored in a nonvolatile storage medium (such as optical disk, flash storage device, mobile hard disk, etc.), including a number of instructions for making a computer device (such as personal computers, servers, network equipment, etc.) implement the methods described in the embodiments of the present invention. The units may be implemented on a single device or distributed across multiple devices.

Displaying unit 41 is configured to display some page elements of a web page at a display area of a client device. Displaying unit 41 is configured to overlay a mobile object on the web page. The mobile object comprises a floating page element. The web page is associated with a set of page elements that is not currently presented. Detecting unit 42 is configured to detect the movement of the mobile object. Determining unit 43 is configured to determine that the movement meets a condition associated with displaying at least page element of the set of page elements that is not presented. Displaying unit 41 is also configured to display the at least one page element associated with the condition.

In some embodiments, displaying unit 41 is further configured to overlay at least one position object on the web page. Each position object comprises a floating page element and is located at a fixed position on the display area of the client device.

In some embodiments, detecting unit 42 is further configured to detect whether the mobile object has moved to at least one of the position objects. If the mobile object has moved to at least one of the position objects, then determining unit 43 is configured to execute a corresponding operation. If the mobile object has not moved to at least one of the position objects, then determining unit 43 does not execute the corresponding operation. Determining unit 43 is configured to execute the corresponding operation only after detecting unit 42 has detected that mobile object has moved to at least one of the position objects.

In a specific example where the client device comprises a touchscreen mobile phone, the movement of the mobile object can be monitored by detecting unit 42 recording the coordinates where the user's finger stops touching/releases the mobile object on the touchscreen and comparing such coordinates to the fixed position of at least one of the position objects. Whether the coordinates where the user's finger stops touching/releases the mobile object on the touchscreen matches to the fixed position of at least one of the position objects (e.g., within a given tolerance) is used by determining unit 43 to determine whether the movement of the mobile object satisfies a condition of a rule.

In a specific example where the client device comprises a touchscreen mobile phone, the movement of the mobile object can be monitored by detecting unit 42 recording the offset value from the coordinates where the user's finger begins to touch the mobile object on the touchscreen to the coordinates where the user's finger stops touching/releases the mobile object. The offset value can be used by determining unit 43 to determine whether the movement of the mobile object satisfies a condition of a rule.

In some embodiments, displaying unit 41 is configured to continue to at least partially display the previously displayed page elements or to no longer display such page elements. Whether the previously displayed page elements to be displayed is determined by the dimensions of the display area and the difference between the dimensions of the display area and the dimensions of the page element to display based on the movement of the mobile object.

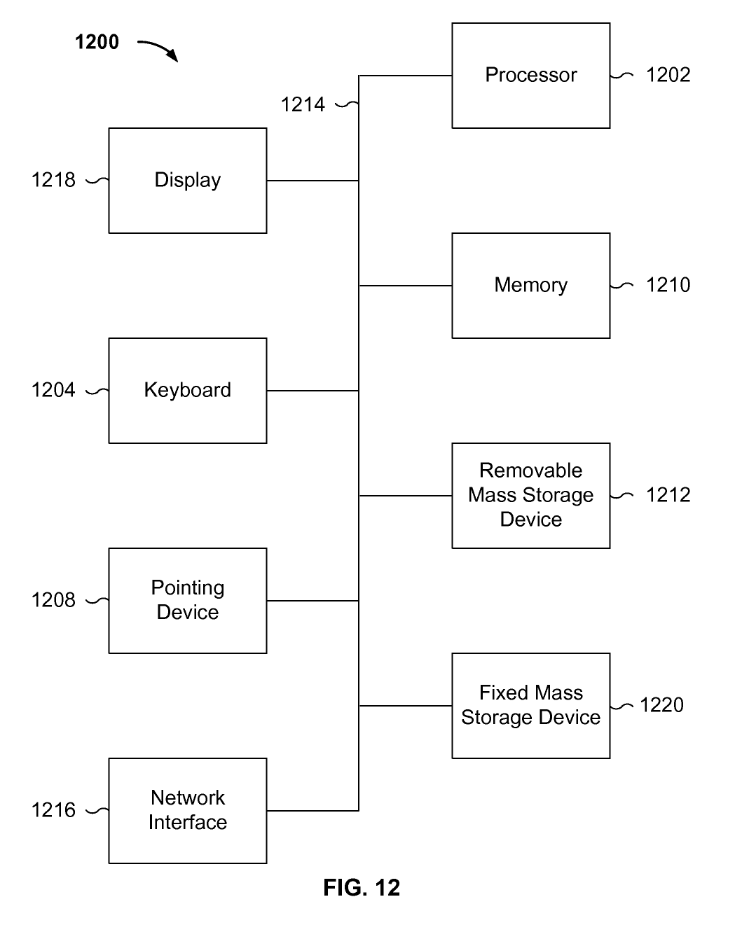

FIG. 12 is a functional diagram illustrating an embodiment of a programmed computer system for implementing the display of page elements. As will be apparent, other computer system architectures and configurations can be used to display page elements. Computer system 1200, which includes various subsystems as described below, includes at least one microprocessor subsystem (also referred to as a processor or a central processing unit (CPU)) 1202. For example, processor 1202 can be implemented by a single-chip processor or by multiple processors. In some embodiments, processor 1202 is a general purpose digital processor that controls the operation of the computer system 1200. Using instructions retrieved from memory 1210, the processor 1202 controls the reception and manipulation of input data, and the output and display of data on output devices (e.g., display 1218). In some embodiments, processor 1202 includes and/or is used to provide the display of page elements.

Processor 1202 is coupled bi-directionally with memory 1210, which can include a first primary storage area, typically a random access memory (RAM), and a second primary storage area, typically a read-only memory (ROM). As is well known in the art, primary storage can be used as a general storage area and as scratch-pad memory, and can also be used to store input data and processed data. Primary storage can also store programming instructions and data, in the form of data objects and text objects, in addition to other data and instructions for processes operating on processor 1202. Also as is well known in the art, primary storage typically includes basic operating instructions, program code, data, and objects used by the processor 1202 to perform its functions (e.g., programmed instructions). For example, memory 1210 can include any suitable computer readable storage media, described below, depending on whether, for example, data access needs to be bi-directional or uni-directional. For example, processor 1202 can also directly and very rapidly retrieve and store frequently needed data in a cache memory (not shown).

A removable mass storage device 1212 provides additional data storage capacity for the computer system 1200 and is coupled either bi-directionally (read/write) or uni-directionally (read only) to processor 1202. For example, storage 1212 can also include computer readable media such as magnetic tape, flash memory, PC-CARDS, portable mass storage devices, holographic storage devices, and other storage devices. A fixed mass storage 1220 can also, for example, provide additional data storage capacity. The most common example of fixed mass storage 1220 is a hard disk drive. Mass storage 1212, 1220 generally store additional programming instructions, data, and the like that typically are not in active use by the processor 1202. It will be appreciated that the information retained within mass storages 1212 and 1220 can be incorporated, if needed, in standard fashion as part of memory 1210 (e.g., RAM) as virtual memory.

In addition to providing processor 1202 access to storage subsystems, bus 1214 can also be used to provide access to other subsystems and devices. As shown, these can include a display 1218, a network interface 1216, a keyboard 1204, and a pointing device 1208, as well as an auxiliary input/output device interface, a sound card, speakers, and other subsystems as needed. For example, the pointing device 1208 can be a mouse, stylus, track ball, or tablet, and is useful for interacting with a graphical user interface.

The network interface 1216 allows processor 1202 to be coupled to another computer, computer network, or telecommunications network using a network connection as shown. For example, through the network interface 1216, the processor 1202 can receive information (e.g., data objects or program instructions) from another network or output information to another network in the course of performing method/process steps. Information, often represented as a sequence of instructions to be executed on a processor, can be received from and outputted to another network. An interface card or similar device and appropriate software implemented by (e.g., executed/performed on) processor 1202 can be used to connect the computer system 1200 to an external network and transfer data according to standard protocols. For example, various process embodiments disclosed herein can be executed on processor 1202, or can be performed across a network such as the Internet, intranet networks, or local area networks, in conjunction with a remote processor that shares a portion of the processing. Additional mass storage devices (not shown) can also be connected to processor 1202 through network interface 1216.

An auxiliary I/O device interface (not shown) can be used in conjunction with computer system 1200. The auxiliary I/O device interface can include general and customized interfaces that allow the processor 1202 to send and, more typically, receive data from other devices such as microphones, touch-sensitive displays, transducer card readers, tape readers, voice or handwriting recognizers, biometrics readers, cameras, portable mass storage devices, and other computers. Persons skilled in the art may clearly understand that, for the sake of descriptive convenience and streamlining, one may refer to the processes in the aforesaid method embodiments that correspond to specific work processes of the systems, devices, and units described above. They will not be discussed further here.

In several embodiments provided by the present application, the disclosed systems, devices, and methods may be realized in other ways. For example, the device embodiments described above are merely illustrative. For example, the division into said units is merely a division by logical function. When actually implemented, there may be other forms of division. For example, multiple units or components may be combined or integrated into another system, or some features might be omitted or not executed. In addition, the interposed couplings or direct couplings or communication connections that are displayed or discussed may be indirect couplings or communication connections that pass through some interfaces, devices, units. They may be electrical or mechanical or may take another form.

The units described as separate components may or may not be physically separate, and components displayed as units may or may not be physical units. They may be located in one place, or they may be distributed across multiple network units. The embodiment schemes of the present application can be realized by selecting part or all of the units in accordance with actual need.

In addition, each functional unit in each of the embodiments of the present application may be integrated into a processing unit, or each unit may have an independent physical existence. Or two or more units may be integrated into one unit. The aforesaid integrated units may take the form of hardware, or they may take the form of hardware combined with software function units.

The aforesaid integrated units that take the form of software function units may be stored in computer-readable storage media. The aforesaid software function units are stored in a storage medium. This includes some commands for causing computer equipment (which could be a personal computer, a server, or network equipment) or a processor to execute some of the steps in the methods described by the various embodiments of the present application. The above-described storage media includes: flash drives, portable hard drives, read-only memory (ROM), random access memory (RAM), magnetic disks, or optical disks, and any other media that can store program codes.

The above embodiments only serve to explain the technical solutions of the present application and not to limit it. Although the present application was explained in detail with reference to the above-described embodiments, persons skilled in the art should understand that they may modify the technical solutions recorded in the various embodiments described above or provide equivalent substitutions for some of their technical features. Yet these modifications or substitutions do not cause the corresponding technical solutions to substantively depart from the spirit and scope of the technical solutions of the various embodiments of the present application.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A system, comprising:
a displayer to:
present a first set of page elements associated with the web page to be displayed, wherein the web page is associated with a second set of page elements that is not presented; and
overlay a mobile object on the web page, wherein the mobile object comprises a floating page element;
a detector to detect a movement associated with the mobile object; and
a determiner to determine that the movement meets a condition associated with displaying at least one page element of the second set of page elements that is not presented, wherein the at least one page element associated with the condition is presented by the displayer.

2. The system of claim 1, wherein the displayer is further to overlay a position object on the web page.

3. The system of claim 2, wherein the condition is met in the event that the movement associated with the mobile object has reached the position object.

4. The system of claim 3, wherein the at least one page element corresponds to the movement associated with the mobile object having reached the position object.

5. The system of claim 1, wherein the condition is met in the event that at least one of a length associated with the movement associated with the mobile object is at least a preset length and the movement associated with the mobile object is in a preset direction relative to an initial position of the mobile object.

6. The system of claim 5, wherein the at least one page element corresponds to the at least one of the length associated with the movement associated with the mobile object being at least the preset length and the movement associated with the mobile object is in the preset direction relative to the initial position of the mobile object.

7. The system of claim 1, wherein the mobile object is operable to be moved by a user action.

8. The system of claim 1, wherein the mobile object remains in an initial position prior to being selected by a user.

9. The system of claim 1, wherein the displayer is further to hide at least a portion of the first set of page elements in response to presenting the at least one page element associated with the condition.

10. A method, comprising:
presenting a first set of page elements associated with the web page to be displayed, wherein the web page is associated with a second set of page elements that is not presented;
overlaying a mobile object on the web page, wherein the mobile object comprises a floating page element;
detecting, using one or more processors, a movement associated with the mobile object;
determining that the movement meets a condition associated with displaying at least one page element of the second set of page elements that is not presented; and
presenting the at least one page element associated with the condition.

11. The method of claim 10, further comprising overlaying a position object on the web page.

12. The method of claim 11, wherein the condition is met in the event that the movement associated with the mobile object has reached the position object.

13. The method of claim 12, wherein the at least one page element corresponds to the movement associated with the mobile object having reached the position object.

14. The method of claim 10, wherein the condition is met in the event that at least one of a length associated with the movement associated with the mobile object is at least a preset length and the movement associated with the mobile object is in a preset direction relative to an initial position of the mobile object.

15. The method of claim 14, wherein the at least one page element corresponds to the at least one of the length associated with the movement associated with the mobile object being at least the preset length and the movement associated with the mobile object is in the preset direction relative to the initial position of the mobile object.

16. The method of claim 10, wherein the mobile object is operable to be moved by a user action.

17. The method of claim 10, wherein the mobile object remains in an initial position prior to being selected by a user.

18. The method of claim 10, further comprising hiding at least a portion of the first set of page elements in response to presenting the at least one page element associated with the condition.

19. A computer program product, the computer program product being embodied in a non-transitory computer readable storage medium and comprising instructions for:
presenting a first set of page elements associated with the web page to be displayed, wherein the web page is associated with a second set of page elements that is not presented;
overlaying a mobile object on the web page, wherein the mobile object comprises a floating page element;
detecting a movement associated with the mobile object;
determining that the movement meets a condition associated with displaying at least one page element of the second set of page elements that is not presented; and
presenting the at least one page element associated with the condition.

20. The computer program product of claim 19, further comprising overlaying a position object on the web page.
